(19) United States
(12) Patent Application Publication
(10) Pub. No.: US 2007/0241535 A1
(43) Pub. Date: Oct. 18, 2007

(54) Mirrored hitch alignment apparatus and method of use

(76) Inventor: Daniel D. Salyers, Ocala, FL (US)

Correspondence Address: Douglas Wm. Massinger, Esq.;Massinger Law Offices, 887 N.E. 100 Street, Ocala, FL, 34479, US

(21) Appl. No.: 11/404,529

(22) Filed: Apr. 14, 2006

(51) Int. Cl. B60D 1/36

(52) U.S. Cl. 280/477

(57) ABSTRACT

A trailer hitch alignment apparatus is comprised of a convex mirror assembly adjustably mounted to a vertical stanchion assembly which in turn is removably mounted within mounting means fixedly attached to the tow bar of a trailer. Vertical stanchion assembly is height adjustable to permit raising or lowering of the mirror assembly to a height which permits it to be viewed by a driver from within a towing vehicle, either directly or via a rear-view-mirror. The mirror assembly is situated substantially over the hitch socket of the trailer and angled until a reflection of the hitch socket is caused to appear in the convex reflective surface of the mirror assembly. Thusly positioned, the driver is able to maneuver the towing vehicle while backing towards the trailer until the hitch ball mounted to the towing vehicle is visibly reflected in the mirror. Continued maneuvering of the vehicle is carried out until the driver visualizes the hitch ball below the hitch socket for subsequent coupling.

### FIELD OF THE INVENTION

The subject invention relates to trailer hitches generally, and to a method and apparatus for facilitating the proper alignment of a trailer hitch ball under a hitch receiver for coupling purposes in particular.

### BACKGROUND OF THE INVENTION

A variety of trailers exist which are adapted for the hauling of boats, campers, recreational vehicles, motorcycles, equipment and other miscellaneous forms of cargo. Such trailers are typically transported by hitching to a towing vehicle by means of a coupling apparatus which in most instances is comprised of a ball and socket type hitch assembly, in which a hitch ball is mounted to the rear of the towing vehicle and a hitch socket which is capable of securely receiving the hitch ball is provided on the front of the trailer. Except for in the case of small utility trailers, most large trailers designed to carry heavy loads will be equipped with a jack used to adjust the height of the front end of the trailer from the ground. Such adjustments are made not only to level the trailer and its contents, but also to elevate the hitch socket to a height suitable for permitting the hitch ball to be maneuvered underneath for coupling purposes. Once the hitch socket is adjusted to the proper height for coupling purposes, the driver is faced with the challenge of maneuvering the ball into proper position.

Because the coupling means is almost always obscured from the drivers view when seated in the vehicle, proper alignment of components for coupling is attendant with significant difficulty. When the driver is alone, the traditional method of obtaining proper alignment involves first observing the relative location of the hitch socket and hitch ball from outside the vehicle, considering the distance that the vehicle must be backed to align the ball under the socket, estimating the degree to which the rear end of the vehicle should be steered left or right during the backing process and then entering the vehicle to execute the envisioned process without actually viewing the components of the coupling apparatus themselves. In most instances, the driver will be required to exit the vehicle to re-evaluate progress, re-estimate the next stage of vehicle movement, execute this new plan and repeat as necessary until proper alignment is obtained. Unfortunately, those familiar with this process are all too familiar with the consequences of misjudging their distance of travel while backing. Failure to accurately estimate and execute distance traveled often results in backing the rear end of the vehicle into the trailer socket assembly causing significant damage to bumpers, tailgates, license plate covers and lights, etc. Misjudging the proper distance by only an inch can result in the need for costly repairs.

Various devices of the prior art have been developed to enable the driver of a towing vehicle to achieve proper alignment of coupling components during hitching. One such device is detailed in U.S. Pat. No. 4,741,111 issued to Emerick in 1988. The Emerick device is comprised of an aiming structure for attachment to the tongue of a tow-type recreational vehicle and the cooperative aligning target affixed to the rear window of a towing vehicle. Essentially, a length of opaque adhesive strip is mounted on the surface of the rear window of the towing vehicle in axial alignment of the hitch ball mounted there below. A length of pipe is attached to the trailer's jack shaft which is in parallel to the vertical axis to the hitch tongue invisible to the driver while seated in the vehicle. As may be appreciated, the driver then aligns the strip of adhesive on the rear view window with the target length of pipe during the backing process. While this device is useful in aligning the hitch ball in the hitch socket in the left or right directions, it is not particularly useful for alignment of such components along an axis perpendicular thereto. Further, it is particularly impractical for use with pick-up trucks wherein the rear windows are not proximately located to the hitch ball.

A similar device employing the use of a vertically aligned target mounted above the hitch socket in combination with an aiming device mounted to the backing vehicle is taught in U.S. Pat. No. 4,621,432 issued to Law in 1986. The Law device comprises a fork-like sighting member attached to the towing vehicle and a flexible sighting poll assembly attached to the trailer hitch. The vehicles are properly aligned when the hitching element bumps the base or tail of the sighting poll causing it to vibrate while being viewed within the fork-like sighting member.

Still another trailer hitch alignment guide is disclosed in U.S. Pat. No. 5,269,554 issued to Law et. al. in 1993 which teaches a plurality of guide assemblies, one of which is mounted to a trailer hitch ball and the other mounted to a trailer tongue, wherein the guides each include telescoping vertical leg members for alignment and communication relative to one another for the positioning of a trailer hitch tongue relative to an associated trailer ball.

A final prior art device directed towards achieving proper alignment of trailer hitch components is disclosed in U.S. Pat. No. 5,113,588 issued to Walston in 1992 and entitled Isomorphic Trailer Hitch Alignment Guide Device. The Walston device teaches a trailer hitch alignment guide device for a ball and socket hitch, wherein the guides can be mounted either to the rear or side, wherein the sighting elements on the guides are visually emblematic of the coupling elements, where one sighting element is isomorphic of the hitch ball and the other sighting element is isomorphic of the socket, and where the sighting elements are scribed with lines which visually amplify deviations of alignment.

Each of the above trailer hitch alignment guide devices are of the “target” genre and require the mounting of cooperating components on both the trailer and on the towing vehicle. None of the above-described references enable the driver to actually see the ball and socket while backing the vehicle which would be of great advantage in the coupling process.

In view of the requirement of assuring proper alignment of hitch ball and receiver components to accomplish coupling thereof, and still further considering the desire to avoid the damage which may occur by failing to properly position such components for coupling, it is apparent that a need exists for a method and apparatus capable of facilitating the proper alignment of a hitch ball and receiver.

### SUMMARY OF THE INVENTION

In accordance with the teachings of the subject invention a trailer hitch alignment apparatus is comprised of a convex mirror assembly adjustably mounted to a vertical stanchion assembly which in turn is removably mounted within mounting means fixedly attached to the tow bar of a trailer. Vertical stanchion assembly is height adjustable to permit raising or lowering of the mirror assembly to a height which permits it to be viewed by a driver from within a towing vehicle, either directly or via a rear-view-mirror. The mirror assembly is situated substantially over the hitch socket of the trailer and angled until a reflection of the hitch socket is caused to appear in the convex reflective surface of the mirror assembly. Thusly positioned, the driver is able to maneuver the towing vehicle while backing towards the trailer until the hitch ball mounted to the towing vehicle is visible. Continued maneuvering of the vehicle is carried out until the hitch ball is aligned below the hitch socket for subsequent coupling.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a trailer hitch alignment apparatus which permits the driver of a towing vehicle to view the hitch components during the coupling procedure.

It is another object of the subject trailer hitch alignment apparatus to assist the driver in the safe and efficient positioning of a hitch ball, mounted to the towing vehicle, to a location immediately beneath the hitch socket for subsequent locking engagement therewith.

Still another primary object of the subject invention is to provide a trailer hitch alignment apparatus employing a mirror which is easily adjustable on a supporting member to achieve a reflection of the hitching components which are viewable by the driver while in the towing vehicle.

Another object of the subject invention is to provide a trailer hitch alignment apparatus which may be quickly installed and uninstalled on the trailer only and does not require the attachment of additional components on the towing vehicle itself.

Another object of the subject invention is to provide a trailer hitch alignment apparatus which is relatively simple in design, comprised of a limited number of components and therefore capable of rapid construction at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a left side view of the subject guide apparatus shown mounted to a tow bar having a first member of a trailer coupling assembly secured thereto, and further illustrates a portion of a tow vehicle having second member of the trailer coupling assembly secured thereto;

FIG. 2 is a rear view of the invention as shown in FIG. 1;

FIG. 3 is an enlarged rear view of the adjustable mirror of the subject invention; and

FIG. 4 is an enlarged frontal view of the adjustable mirror of the subject invention as seen from the driver's point-of-view during use.

### REFERENCE NUMBER LIST

10 Hitch Guide
12 Stanchion Assembly
14 Mirror Assembly
16 Mounting Means
18 Vertical Support Rod
20 Angled Joint Member
22 Tow Bar
24 Trailer
26 Distal End of Angled Joint Member
28 Mirror Attachment Means
30 First Shaft End
32 Shaft
34 Second Shaft End
36 Ball
38 Ball-and-Socket Joint
40 Mirror Housing
42 Mirror
44 Reflective Surface
46 Cylinder
48 Jack Stand
50 C-Brackets
52 Cylinder Closure Means
54 Collar
56 Tongue
58 Socket
60 Hitch Ball
62 Towing Vehicle
64 Crank
66 Hitch Lock
68 Chains
70 Chain Recovery Means
72 Electrical Wires

### DETAILED DESCRIPTION OF THE PREFERRED EMBODIMENT

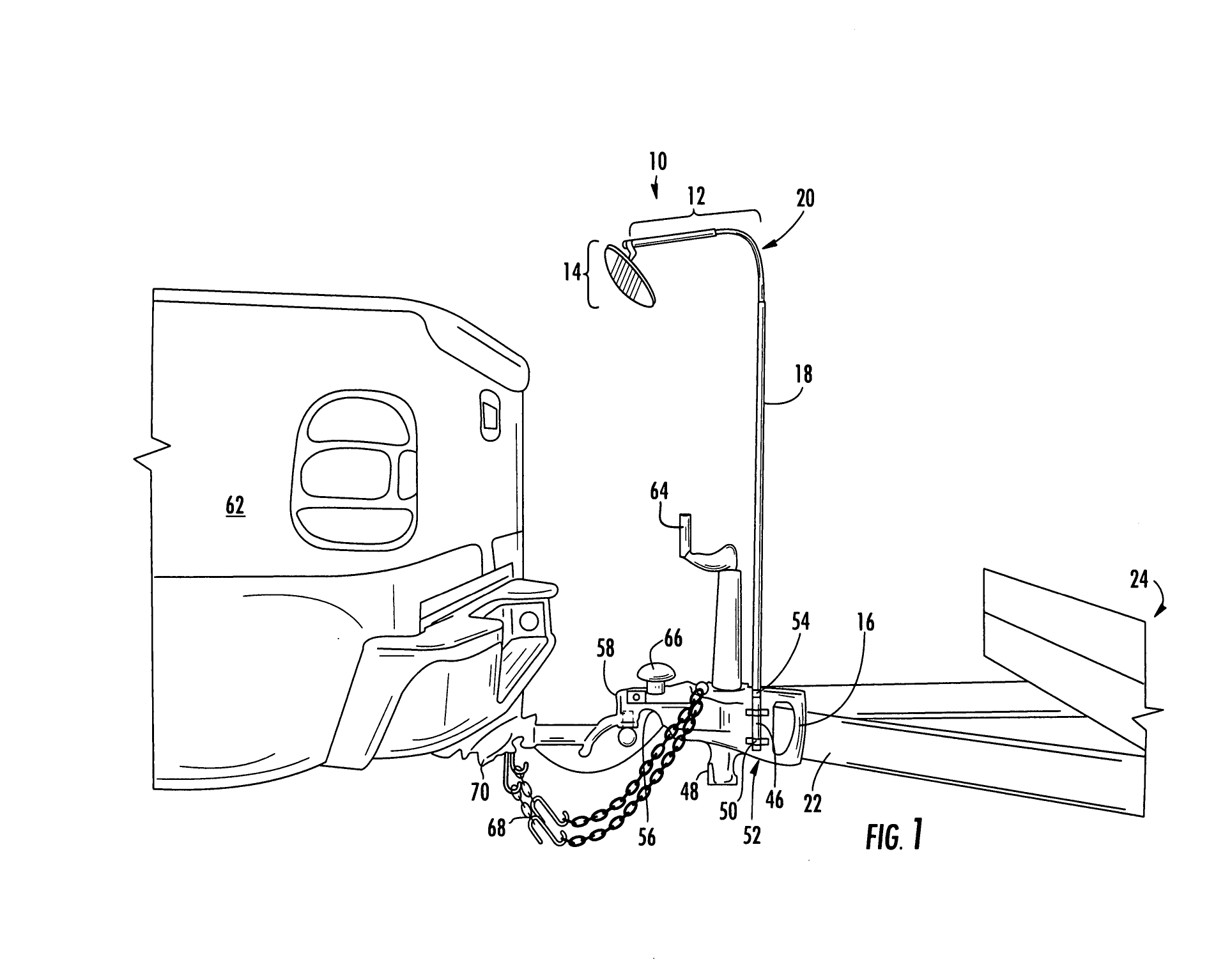

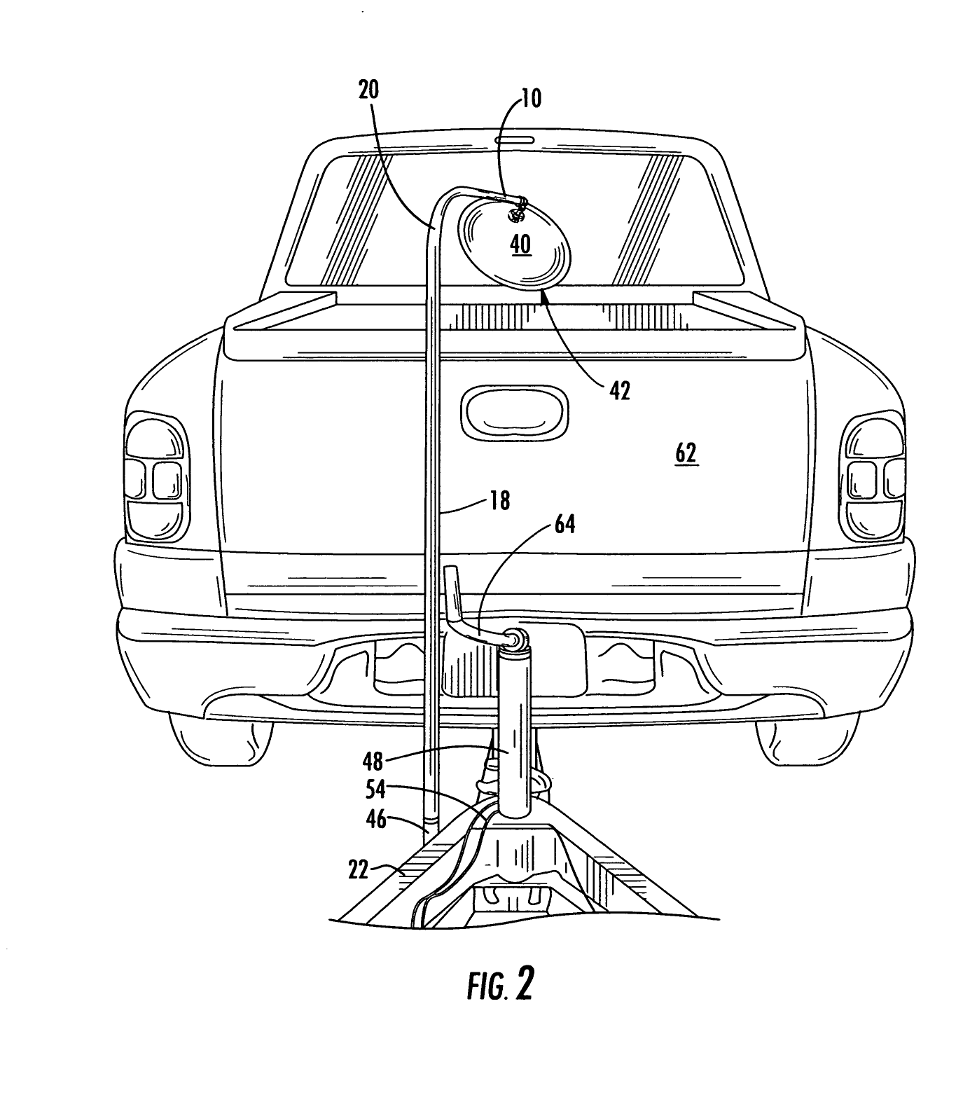

Reference is now made to FIGS. 1 and 2 in which there is illustrated side and rear views respectively of the subject trailer hitch alignment apparatus (hereinafter sometimes also referred to as simply “hitch guide”), designated generally by reference numeral 10. A preferred embodiment of the subject invention is comprised of three primary components, namely elongate angled stanchion assembly 12, adjustable mirror assembly 14, and stanchion mounting means 16, each of which are more fully described below in seriatim.

Stanchion assembly 12 is comprised of at least one length of an elongated vertical support member or rod 18 in slidable engagement with angled joint member 20 which is a cantilever extending horizontally from the vertical support rod. Additional vertical support rods may be attached to one another in series to increase the height of angled joint member 20 above the tow bar 22 of trailer 24 as further described herein. Alternatively, vertical support rod 18 may be of telescopic construction (not shown) such that it is capable of lockable adjustment to a variety of heights as is well known to those skilled in the art. Both support rod 18 and angled joint member 20 are preferably, but not essentially, constructed of half inch thin wall pipe. Angled joint member 20 preferably, but not essentially, has a 24 inch sweep and serves to transition stanchion assembly 12 from a vertical orientation to a substantially perpendicular and horizontal orientation relative to the ground. It should be appreciated that

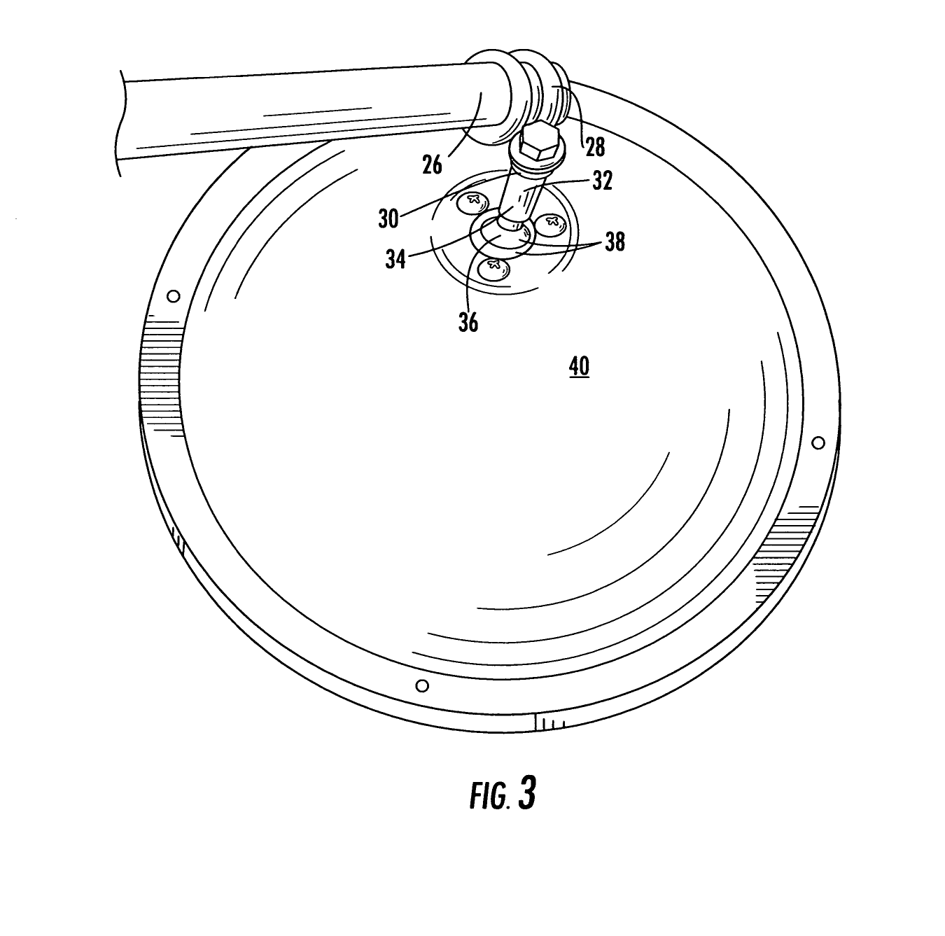

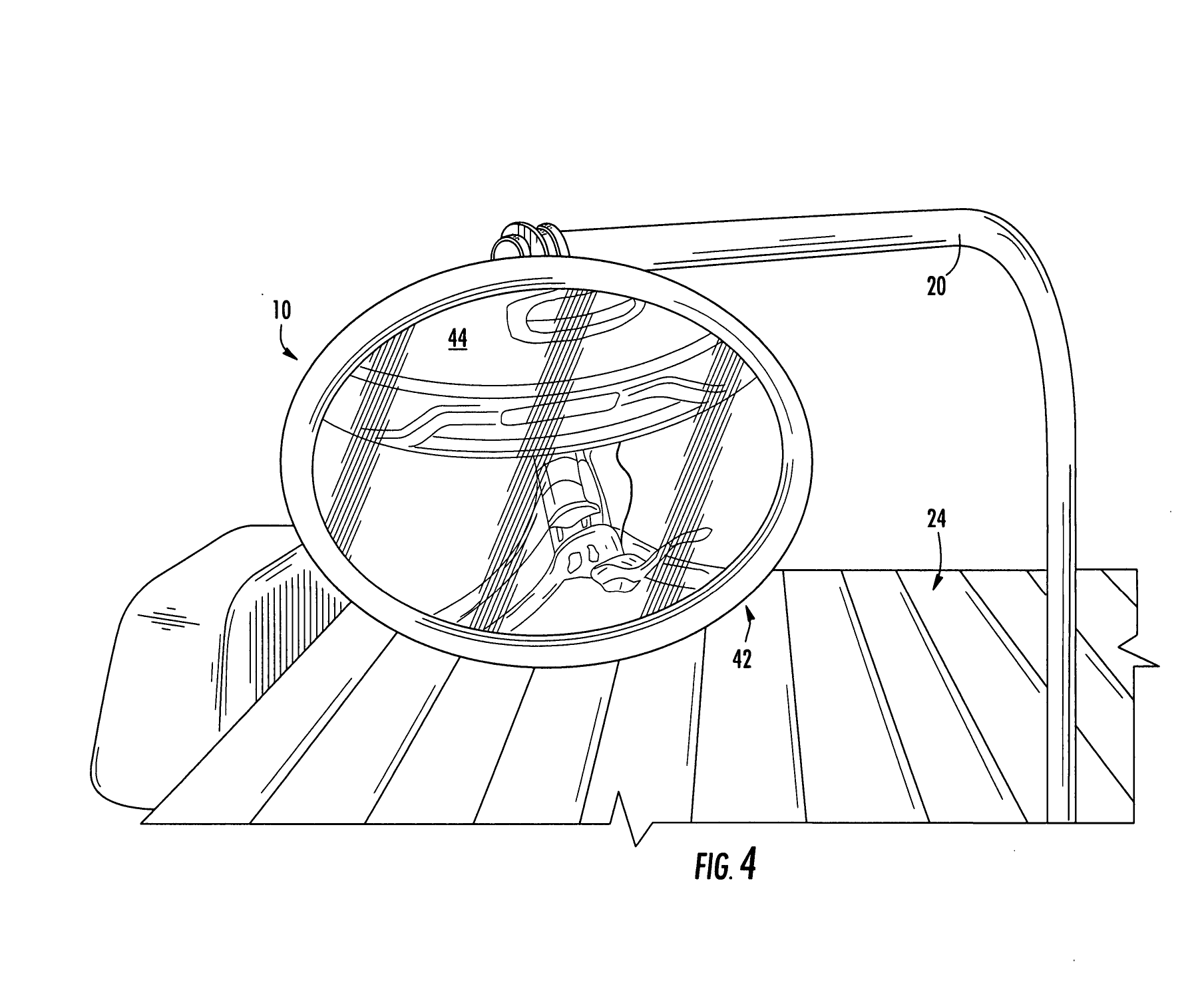

Referring now to FIG. 3, angled joint member 20 terminates at its distal end 26 in mirror attachment means 28 illustrated as a ring clamp removably fastened about the circumference of distal end 26 and adapted to receive first shaft end 30 of shaft 32. A second shaft end 34 of shaft 30 is adapted to receive ball 36 of ball-and-socket joint 34. As may be readily appreciated, ball-and-socket joint 38 permits limited rotation of housing 40 of mirror 42 to achieve adjustment of convex light reflective surface 44 (FIG. 4) as described below.

Referring once again to FIG. 1, stanchion mounting means 16 is comprised of cylinder 46 vertically and fixedly mounted to tow bar 22 behind jack stand 48 using a pair of c-brackets 50 or by other suitable means. Cylinder 46 has a diameter greater than that of vertical support rod 18 such that it may slidably receive support stanchion assembly 12 therein. Closure means 52 illustrated in the form of an end cap fixedly mounted to the bottom end of cylinder 46 serves to limit the extent of travel of vertical support rod 18 within mounting means 16. Alternatively, bottom end of cylinder 46 may be left open so as to prevent rain water and other foreign matter from becoming trapped therein. In such a case, adjustment collar 54 is permanently mounted to the top end of cylinder 46 to limit the degree of axial travel of support rod 18 within cylinder 46. Collar 54 thereby serves as a rod height adjustment mechanism.

A preferred embodiment of the subject invention having been described in detail, its method of use may be described with continued reference to FIGS. 1 and 2. The conventional trailer hitch of trailer 24 includes a tongue 56 having a hollowed socket 58 which are both situated forward of jack stand 48. Socket 58 is of such dimensions as to be seated on hitch ball 60 when coupled together as illustrated. Once vertical stanchion assembly 12 is properly seated within mounting means 16, mirror assembly 14 may be rotated until reflective surface 44 is substantially over socket 58 and facing the rear window of towing vehicle 62. While facing trailer 24, housing 40 of mirror assembly 14 may then be manipulated about ball-and-socket joint 38 to a selected angle that causes appearance of hitch socket 58 in reflective surface 44 of mirror 42.

As best observed upon review of FIG. 2, note that mirror assembly 14 must be visible to the driver when seated within towing vehicle 62, either directly or via a rear-view mirror or both. Vertical adjustment of mirror assembly 14 is accomplished by loosening collar 54 and raising or lowering vertical support rod 18 to the desired height and then retightening collar 54. As the driver backs towing vehicle 62 towards trailer 24, hitch ball 60 will also appear in reflective surface 44 of mirror 42 (FIG. 4). With the reflections of both hitch ball 60 and socket 58 in view on reflective surface 44, the driver maneuvers towing vehicle 62 as needed to achieve alignment of the former beneath the latter for subsequent coupling. Coupling is accomplished by lowering socket 58 around hitch ball 60 using crank 64 of jack stand 48.

Subsequent to coupling, the subject apparatus may be removed from its mounting means 16 which will remain permanently affixed to tow bar 22 of trailer 24. The balance of the apparatus may be stored in either the towing vehicle or trailer. Hitching is completed by conventional means including activation of a hitch lock 66 adjacent tongue 56 and attachment of chains 68 provided on tow bars 22 to receiving means 70 of the towing vehicle. Connection of electrical wires 72 used to activate brake lights, turn signals and backing lights (not shown) is also common.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A trailer hitch alignment apparatus, comprising:
a. a height-adjustable vertical member mounted at one end to the tow bar of a trailer and terminating at its opposite end in a cantilever;
b. a convex mirror assembly adjustably mounted to said cantilever; said convex mirror assembly having a reflective surface situated substantially over the hitch socket of the trailer;
whereby said mirror assembly is angled until a reflection of the hitch socket may be seen in said reflective surface by an occupant of a towing vehicle either directly or in the vehicle's rear-view mirror to facilitate coupling of a hitch ball and hitch socket.

2. A method of facilitating the alignment of a towing vehicle's hitch ball beneath a trailer's hitch socket, the method comprising the steps of:
a. mounting a first end of a height-adjustable vertical member to the tow bar of the trailer;
b. adjustably mounting a convex mirror assembly to a cantilever extending from said vertical support member; said convex mirror assembly having a reflective surface;
c. positioning said convex mirror assembly substantially above the hitch socket of the trailer;
d. adjusting the angle of said convex mirror assembly until a reflection of the hitch socket may be seen in said reflective surface by an occupant of the towing vehicle either directly or in the vehicle's rear-view mirror to facilitate coupling of a hitch ball and hitch socket.
